(19) United States
(12) Patent Application Publication
(10) Pub. No.: US 2024/0027982 A1
(43) Pub. Date: Jan. 25, 2024

(54) HOUSEHOLD APPLIANCES INTENTIONAL INPUT DETECTION

(71) Applicant: Haier US Appliance Solutions, Inc., Wilmington, DE (US)

(72) Inventors: Haitian Hu, Louisville, KY (US); Hairong Li, Louisville, KY (US)

(21) Appl. No.: 17/869,027

(22) Filed: Jul. 20, 2022

(51) Int. Cl. G05B 19/042; H04L 12/28; G06F 3/01; G06V 40/16

(52) U.S. Cl. CPC G05B 19/042; H04L 12/2814; G06F 3/011; G06V 40/172; G05B 2219/24034

(57) ABSTRACT

Household appliances and methods of operating household appliances are provided. The household appliance includes a user input device and a controller in operative communication with the user input device. Such methods include, or household appliances are configured for, downloading an input verification software from a remote computing device to the household appliance. An input at the user input device is detected. The methods also include, or the household appliances are also configured for, determining, by the controller of the household appliance using the input verification software, whether the detected input was intentional.

### FIELD OF THE INVENTION

The present subject matter relates generally to household appliances, and more particularly to methods of verifying an input on a household appliance.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a dishwasher, etc., along with room air conditioners and other various appliances.

In many situations, unintentional operation of a household appliance may be undesirable. For example, some household appliances may include features which generate high levels of heat, e.g., burners on a cooktop or oven appliance, or a heating system of a dryer appliance, and/or may include enclosable internal volumes, such as inside of a drum of a dryer appliance. Accordingly, many household appliances include components or features, such as a burner of a cooktop when a non-food item is present thereon or a drum of a dryer appliance when heat-sensitive items are present therein, for which it is desirable to limit or prevent unintentional activation.

Accordingly, household appliances and methods of verifying an input at such appliances, e.g., detecting an intentional input and/or ignoring an unintentional input, are desirable.

### BRIEF DESCRIPTION OF THE INVENTION

Aspects and advantages of the invention will be set forth in part in the following description, or may be obvious from the description, or may be learned through practice of the invention.

In one aspect of the present disclosure, a method of operating a household appliance is provided. The household appliance includes a user input device and a controller in operative communication with the user input device. The method includes downloading an input verification software from a remote computing device to the household appliance. The method also includes detecting an input at the user input device and determining, by the controller of the household appliance using the input verification software, whether the detected input was intentional.

In another aspect of the present disclosure, a household appliance is provided. The household appliance includes a user input device and a controller in operative communication with the user input device. The controller is configured for downloading an input verification software from a remote computing device to the household appliance. The controller is also configured for detecting an input at the user input device and determining, using the input verification software, whether the detected input was intentional.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary dryer appliance in accordance with one or more exemplary embodiments of the present disclosure.

FIG. 2 provides a perspective view of the exemplary dryer appliance of FIG. 1 with portions of a cabinet of the laundry appliance removed to reveal certain components of the dryer appliance.

FIG. 3 provides a perspective view of an oven appliance according to one or more exemplary embodiments of the present subject matter.

FIG. 4 provides a section view of the oven appliance of FIG. 3 taken along line 4-4 of FIG. 3.

FIG. 5 provides a diagrammatic illustration of a camera assembly in a household appliance according to one or more exemplary embodiments of the present subject matter.

FIG. 6 provides a diagrammatic illustration of a household appliance in communication with a remote computing device and with a remote user interface device according to one or more exemplary embodiments of the present subject matter.

FIG. 7 provides a flow chart illustrating an exemplary method of operating a household appliance in accordance with at least one embodiment of the present subject matter.

FIG. 8 provides a flow chart illustrating another exemplary method of operating a household appliance in accordance with one or more additional embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Directional terms such as “left” and “right” are used herein with reference to the perspective of a user standing in front of a household appliance to access the appliance and/or items therein. Terms such as “inner” and “outer” refer to relative directions with respect to the interior and exterior of the appliance. For example, “inner” or “inward” refers to the direction towards the interior of the appliance. Terms such as “left,” “right,” “front,” “back,” “top,” or “bottom” are used with reference to the perspective of a user accessing the appliance. For example, a user stands in front of the appliance to open the door(s) and reaches into the appliance to add, move, or withdraw items therein.

As used herein, the terms “first,” “second,” and “third” may be used interchangeably to distinguish one component from another and are not intended to signify location or importance of the individual components. As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

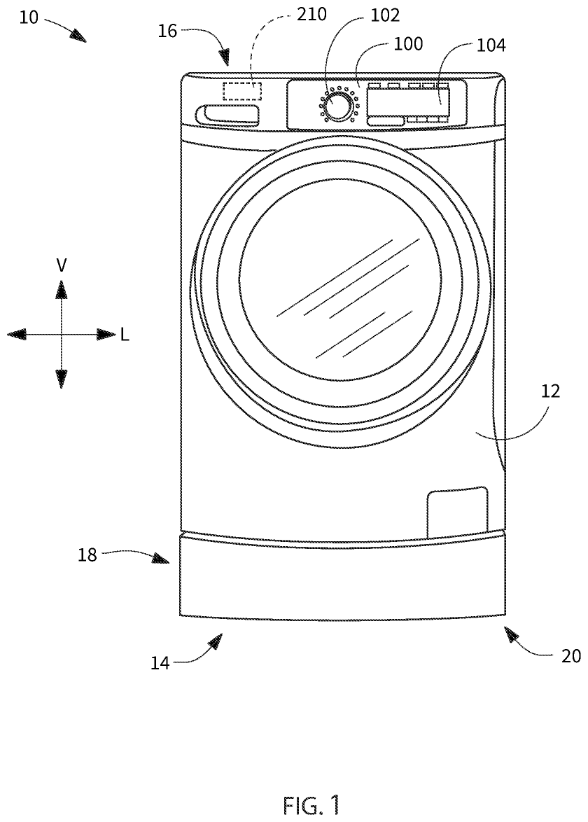

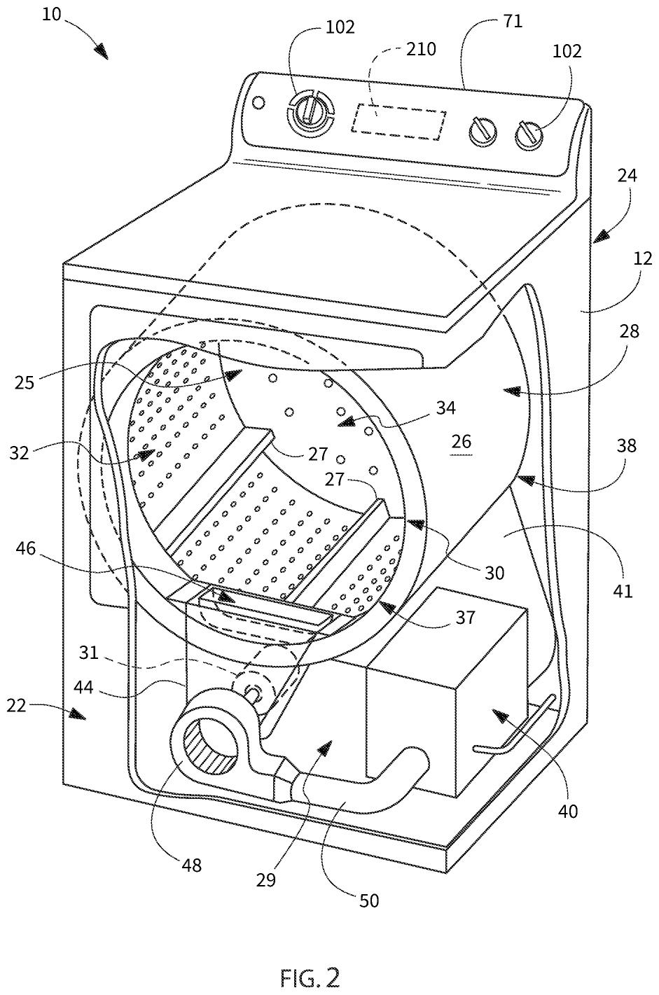

As may be seen in FIGS. 1 and 2, in accordance with one or more embodiments of the present subject matter, a household appliance may be a laundry appliance such as dryer appliance 10. The dryer appliance 10 is an example embodiment of a household appliance 10 which may be usable in one or more exemplary methods described herein and/or may be operable and configured to perform such methods.

As generally seen throughout FIGS. 1 through 4, in at least some embodiments, each appliance 10 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

Each household appliance 10 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102.

Generally, each appliance 10 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance 10. Operation of the appliance 10 may be regulated by the controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the household appliance 10 may be a laundry appliance. In embodiments such as illustrated in FIG. 1, the user input device 102 of the appliance 10 may be positioned on the user interface panel 100. The embodiment illustrated in FIG. 1 also includes a display 104 on the user interface panel 100 of the household appliance 10.

Additional exemplary details of the laundry appliance, e.g., dryer appliance 10, are illustrated in FIG. 2. FIG. 2 provides a perspective view of the dryer appliance 10 of FIG. 1, which is an example embodiment of a household appliance 10, with a portion of a cabinet or housing 12 of dryer appliance 10 removed in order to show certain components of dryer appliance 10. Dryer appliance 10 generally defines a vertical direction V, a lateral direction L, and a transverse direction T, each of which is mutually perpendicular, such that an orthogonal coordinate system is defined. While described in the context of a specific embodiment of dryer appliance 10, using the teachings disclosed herein, it will be understood that dryer appliance 10 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 10 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontrollers, application-specific integrated controllers (ASICS), or semiconductor devices and is not restricted necessarily to a single element. The controller 210 may be programmed to operate dryer appliance 10 by executing instructions stored in memory (e.g., non-transitory media). The controller 210 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

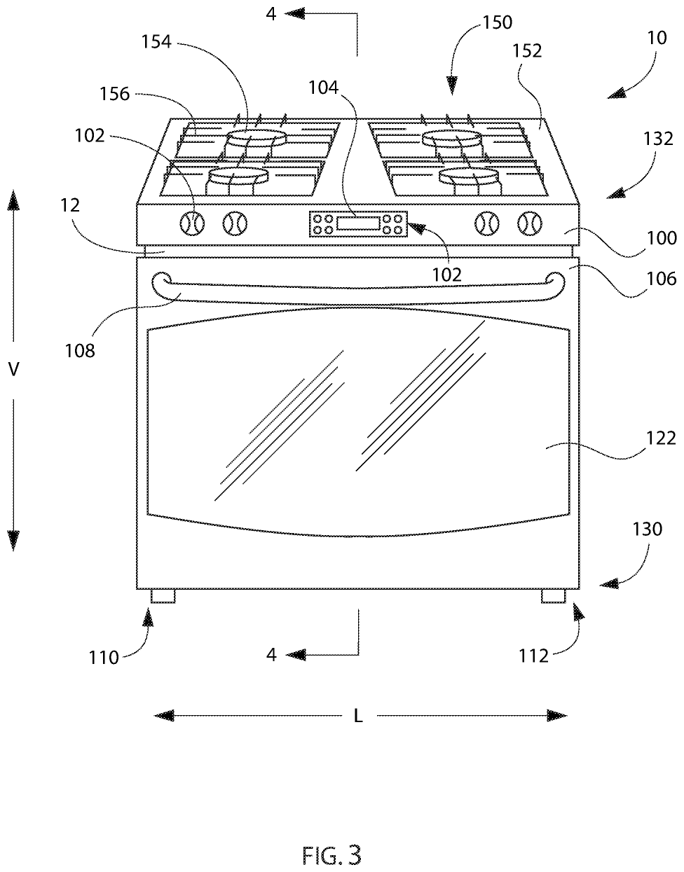

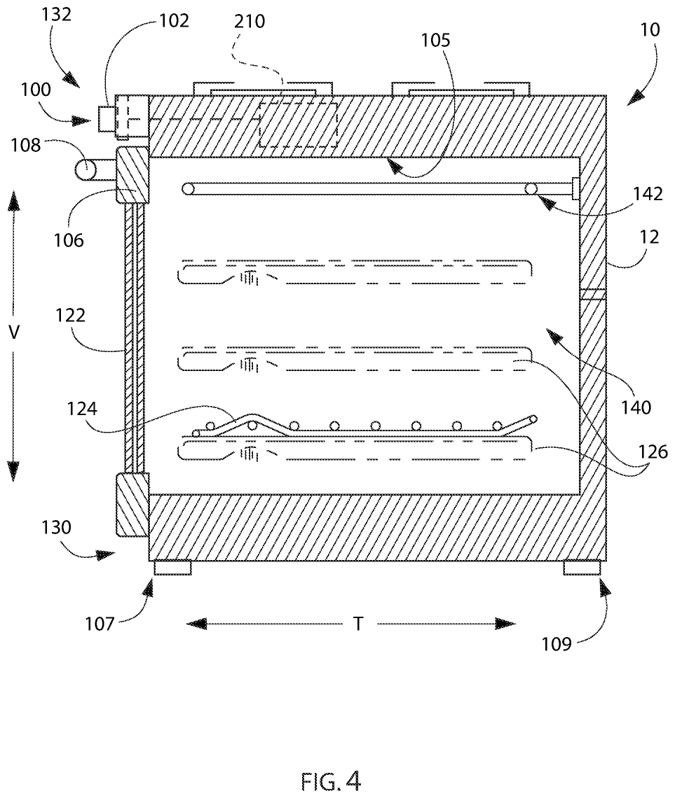

In another example embodiment, the household appliance 10 may be a cooking appliance, such as an oven appliance 10, e.g., as illustrated in FIGS. 3 and 4.

FIG. 3 provides a front perspective view of an oven appliance 10 according to exemplary embodiments of the present subject matter. FIG. 4 provides a section view of exemplary oven appliance 10 taken along line 4-4 of FIG. 3. Oven appliance 10 is shown in FIGS. 3 and 4 as a free-standing range oven appliance, but it will be appreciated that oven appliance 10 is provided by way of example only and is not intended to limit the present subject matter in any aspect. Other cooking appliances having different configurations, different appearances, and/or different features may also be utilized with the present subject matter as well. Thus, the present subject matter may be used with other oven appliance configurations, e.g., wall ovens and/or oven appliances that define one or more interior cavities for the receipt of food items and/or having different pan or rack arrangements than what is shown in FIG. 4, as well as with cooktop-only appliances.

Oven appliance 10 includes an insulated cabinet 12 with an interior cooking chamber 140 defined by an interior surface 105 of cabinet 12. Cooking chamber 140 is configured for receipt of one or more food items to be cooked. Cabinet 12 extends between a bottom portion 130 and a top portion 132 along a vertical direction V. Cabinet 12 also extends between a front portion 107 and a back portion 109 along a transverse direction T and between a first side 110 and a second side 112 along a lateral direction L. Vertical direction V, lateral direction L, and transverse direction T are mutually perpendicular and form an orthogonal direction system.

Oven appliance 10 includes a door 106 rotatably mounted to cabinet 12, e.g., with a hinge (not shown). A handle 108 is mounted to door 106 and assists a user with opening and closing door 106. For example, a user can pull or push handle 108 to open or close door 106 to access cooking chamber 140. Oven appliance 10 includes a seal (not shown) between door 106 and cabinet 12 that maintains heat and cooking fumes within cooking chamber 140 when door 106 is closed as shown in FIGS. 3 and 4. Multiple parallel glass panes 122 provide for viewing the contents of cooking chamber 140 when door 106 is closed and provide insulation for cooking chamber 140. A baking rack 124 is positioned in cooking chamber 140 for receipt of food items or utensils containing food items. Baking rack 124 is slidably received onto embossed ribs or sliding rails 126 such that rack 124 may be conveniently moved into and out of cooking chamber 140 when door 106 is open.

A top heating element or broil element 142 is positioned in cooking chamber 140 of cabinet 12 proximate top portion 132 of cabinet 12. Top heating element 142 is used to heat cooking chamber 140 for both cooking/broiling and cleaning of household appliance 10. The size and heat output of top heating element 142 can be selected based on, e.g., the size of oven appliance 10. In the exemplary embodiment shown in FIG. 2, top heating element 142 is shown as an electric resistance heating element. In additional embodiments, the top heating element 142 may be any suitable heating element, e.g., a magnetron, a gas burner, a heat lamp, and combinations of one or more of such heating elements of the same or varied types. In some embodiments, oven appliance 10 may include one or more heating elements in addition to or other than the top heating element, such as a bottom heating element, which may include an electric resistance heating element, an induction heating element, a magnetron, a gas burner, a heat lamp, and combinations of one or more of such heating elements of the same or varied types.

As shown in FIG. 3, oven appliance 10 includes a cooktop 150. Cooktop 150 is disposed on and is attached to or integral with cabinet 12. Cooktop 150 includes a top panel 152, which by way of example may be constructed of glass, ceramics, enameled steel, or combinations thereof. One or more burners 154 extend through top panel 152. A utensil (e.g., pots, pans, etc.) holding food and/or cooking liquids (e.g., oil, water, etc.) may be placed onto grates 156 disposed adjacent burners 154. Burners 154 provide thermal energy to cooking utensils placed on grates 156. Burners 154 can be any suitable type of burners, including e.g., gas, electric, electromagnetic, a combination of the foregoing, etc. It will be appreciated that the configuration of cooktop 150 is provided by way of example only and that other suitable configurations are contemplated.

Oven appliance 10 includes a user interface panel 100. For this exemplary embodiment, the user input devices 102 of the user interface panel 100 include a number of knobs 102 (e.g., knobs are an embodiment of a user input device 102) that each correspond to one of the burners 154. Knobs 102 allow users to activate each burner 154 and to determine the amount of heat input provided by each burner 154 to a cooking utensil located thereon.

User interface panel 100 also includes a display component 104 that provides visual information to a user and may also allow the user to select various operational features for the operation of oven appliance 10, e.g., the display component 104 may be a touchscreen which is configured to receive user input by a touch on the screen. In some embodiments, the oven appliance 10 may include one or more touchpad buttons 102 (which are another exemplary embodiment of user input devices 102), as well as or instead of the display component 104, e.g., when the display component 104 is not provided or is not a touchscreen. One or more of a variety of electrical, mechanical or electro-mechanical input devices including rotary dials, push buttons, toggle/rocker switches, and/or touch pads can also be used singularly or in combination as user input devices 102.

The display component 104 on user interface panel 100 may present certain information to users, such as, e.g., whether a particular burner 154 is activated and/or the level at which the burner 154 is set. Display 104 can be a touch sensitive component (e.g., a touch-sensitive display screen) that is sensitive to the touch of a user input object (e.g., a finger or a stylus). Display 104 may include one or more graphical user interfaces that allow for a user to select or manipulate various operational features of oven appliance 10 or its cooktop 150.

Referring now specifically to FIG. 4, the operation of oven appliance 10 is controlled by a processing device or controller 210. As shown, controller 210 is communicatively coupled with user interface panel 100 and its user input devices 102. Controller 210 may also be communicatively coupled with various operational components of oven appliance 10 as well, such as a heating assembly, e.g., heating element 142 and/or other similar heating elements which may be provided, as discussed above, temperature sensors, cameras, speakers, and microphones, etc. Input/output (“I/O”) signals may be routed between controller 210 and the various operational components of oven appliance 10. Thus, controller 210 can selectively activate and operate these various components. Various components of oven appliance 10 are communicatively coupled with controller 210 via one or more communication lines (e.g., represented by dashed lines in FIG. 4), such as, e.g., signal lines, shared communication busses, or wirelessly.

Controller 210 includes one or more memory devices and one or more processors (not labeled). The processors can be any combination of general or special purpose processors, CPUs, or the like that can execute programming instructions or control code associated with operation of oven appliance 10. The memory devices may represent random access memory such as DRAM or read only memory such as ROM or FLASH. In one embodiment, the processor executes programming instructions stored in memory. The memory may be a separate component from the processor or may be included onboard within the processor. Alternatively, controller 210 may be constructed without using a processor, e.g., using a combination of discrete analog and/or digital logic circuitry (such as switches, amplifiers, integrators, comparators, flip-flops, AND gates, and the like) to perform control functionality instead of relying upon software. Controller 210 may include a network interface such that controller 210 can connect to and communicate over one or more networks with one or more network nodes. Controller 210 can also include one or more transmitting, receiving, and/or transceiving components for transmitting/receiving communications with other devices communicatively coupled with oven appliance 10. Additionally or alternatively, one or more transmitting, receiving, and/or transceiving components can be located off board controller 210. Controller 210 can be positioned in a variety of locations throughout oven appliance 10. For this embodiment, controller 210 is located proximate user interface panel 100 toward top portion 132 of oven appliance 10.

User interface panel 100, including user input devices 102 and display component 104, collectively provides a local user interface of oven appliance 10. Thus, user interface panel 100 and the local user interface provide a means for users to communicate with and operate oven appliance 10. It will be appreciated that other components or devices that provide for communication with oven appliance 10 for operating oven appliance 10 may also be included in user interface. For example, the local user interface of the oven appliance 10 (as well as other household appliances 10 in various embodiments of the present disclosure) may include a speaker, a microphone, a camera or motion detection camera, e.g., for detecting a user's proximity to oven appliance 10 or for picking up certain motions, and/or other user interface elements in various combinations.

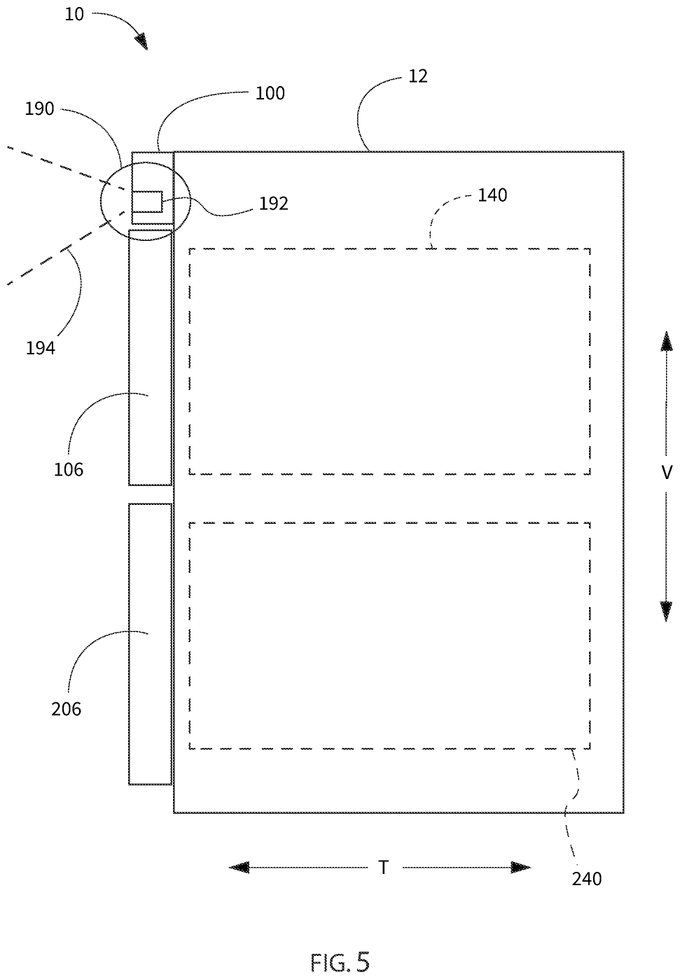

As will be described in more detail below, the household appliance 10 may further include features that are generally configured to detect the presence and/or identity of a user. In various embodiments, the presence and/or identity of the user may be detected from one or more biometric data of the user. In some exemplary embodiments, such features may include one or more sensors, e.g., cameras 192 (see, e.g., FIG. 5), or other detection devices that are used to monitor the household appliance 10 and an area in front of the cabinet 12, such as an area in which a user accessing the household appliance 10 (e.g., cooking chamber 140 and/or cooktop 150 in embodiments where the household appliance is an oven appliance or drum 26 in embodiments where the household appliance is a dryer appliance) is likely to be present. The sensors or other detection devices may be operable to detect and monitor presence of one or more users that are accessing the household appliance 10. In this regard, the household appliance 10, e.g., controller 210 thereof, may use data from each of these devices to obtain a representation or knowledge of the identity, position, and/or other qualitative or quantitative characteristics of one or more users. The controller 210 may obtain such data from the detection devices via a wired or wireless connection. For example, the controller 210 may be communicatively coupled with the one or more detection devices via a wired connection or a wireless connection. Such wireless connections may be provided between the controller 210 (or other similar controller, e.g., processing device, of the household appliance 10) and one or more detection devices which are mounted to or within the cabinet 12, such as the camera assembly 190 illustrated in FIG. 5 and described below, or to one or more detection devices outside of, e.g., remote from, the household appliance 10. For example, a camera of a remote user interface device, e.g., a smartphone camera, may be used as well as or instead of a built-in camera of the household appliance 10.

As shown schematically in FIG. 5, the user detection system may include a camera assembly 190 that is generally positioned and configured for obtaining images of household appliance 10 and adjoining areas, e.g., in front of the household appliance 10, during operation of the camera assembly 190. Specifically, according to the illustrated embodiments in FIG. 5, camera assembly 190 includes one or more cameras 192. The one or more cameras 192 may be mounted to cabinet 12, to door 106, or otherwise positioned in view of cooking chamber 140 (e.g., in embodiments such as the exemplary embodiment illustrated in FIG. 5 where the household appliance 10 is an oven appliance, or in view of the drum 26 in embodiments where the household appliance is a dryer appliance), and/or an area in front of the cabinet 12 that is contiguous with the cooking chamber 140 (or the chamber 25 in dryer appliance embodiments) when the door 106 is open. Such positioning may include positioning the one or more cameras 192 on, in, or outside of the cabinet 12. For example, the household appliance 10 may be positioned close to a second household appliance, such as an over-the-range microwave oven or user engagement system in embodiments where the household appliance 10 is an oven appliance or cooktop appliance or a washing machine appliance in embodiments where the household appliance is a dryer appliance, etc. In such embodiments, the second household appliance may include a camera and the household appliance 10 may receive or obtain images from the camera of the second household appliance. As shown in FIG. 5, a camera 192 of camera assembly 190 is mounted to user interface panel 100 at the front portion 107 of cabinet 12 and is forward-facing, e.g., is oriented to have a field of vision or field of view 194 directed towards an area in front of the cabinet 12, such as directly and immediately in front of the cabinet 12.

As noted above, the configuration of oven appliance 10 illustrated in FIGS. 3 and 4 is by way of example only, and aspects of the present disclosure may also be used with other cooking appliances, such as cooktop appliances, wall ovens, or various other oven appliances having different heating elements, such as gas burners on the cooktop and/or one or more gas heating elements in the cooking chamber, or other heating elements, as well as variations in the number or size of burners, or variations in the location, position, or type of controls on the user interface, among numerous other possible variations in the configuration of the oven appliance 10 within the scope of the present disclosure. For example, FIG. 5 illustrates an exemplary embodiment of the oven appliance 10 which includes a second cooking chamber 240 defined in the cabinet 12 with a second door 206 associated with the second cooking chamber 240, e.g., FIG. 5 illustrates an exemplary double oven embodiment.

Although a single camera 192 is illustrated in FIG. 5, it should be appreciated that camera assembly 190 may include a plurality of cameras 192, wherein each of the plurality of cameras 192 has a specified monitoring zone or range positioned in and/or around household appliance 10, such as multiple cameras in or facing towards the cooking chamber 140 (or chamber 25), such as in the door 106 or second door 206, and/or a second forward-facing camera, e.g., in between the cooking chamber 140 and the second cooking chamber 240 along the vertical direction V. In this regard, for example, the field of view 194 of each camera 192 may be limited to or focused on a specific area.

In some embodiments, it may be desirable to activate the camera or cameras 192 for limited time durations and only in response to certain triggers. For example, the one or more cameras 192 of the camera assembly 190 may also or instead include an infrared (IR) camera. In some embodiments, the IR camera may be operated as a proximity sensor, e.g., the IR camera may be paired with at least one photo camera such that the photo camera is only activated after the proximity sensor (e.g., IR camera and/or other proximity sensor) detects motion at the front of the household appliance 10. In additional embodiments, the activation of the photo camera may be in response to a door opening, such as detecting that the door 106 or second door 206 was opened using a door switch. In this manner, privacy concerns related to obtaining images of the user of the household appliance 10 may be mitigated. According to exemplary embodiments, camera assembly 190 may be used to facilitate an input detection and/or validation process for household appliance 10. As such, each camera 192 may be positioned and oriented to monitor one or more areas of the household appliance 10 and adjoining areas, such as while a user is accessing or attempting to access the household appliance 10, e.g. to select, activate, or otherwise manipulate one or more of the user input devices 102.

It should be appreciated that according to alternative embodiments, camera assembly 190 may include any suitable number, type, size, and configuration of camera(s) 192 for obtaining images of any suitable areas or regions within or around household appliance 10. In addition, it should be appreciated that each camera 192 may include features for adjusting the field of view and/or orientation.

It should be appreciated that the images obtained by camera assembly 190 may vary in number, frequency, angle, resolution, detail, etc. in order to improve the clarity of the particular regions surrounding or within household appliance 10. In addition, according to exemplary embodiments, controller 210 may be configured for illuminating the cooking chamber 140, chamber 25, or other portion or component of the household appliance 10 using one or more light sources prior to obtaining images. Notably, controller 210 of household appliance 10 (or any other suitable dedicated controller) may be communicatively coupled to camera assembly 190 and may be programmed or configured for analyzing the images obtained by camera assembly 190, e.g., in order to detect and/or identify a user proximate to the household appliance 10, as described in more detail below.

In general, controller 210 may be operably coupled to camera assembly 190 for analyzing one or more images obtained by camera assembly 190 to extract useful information regarding objects or people within the field of view 194 of the one or more cameras 192. In this regard, for example, images obtained by camera assembly 190 may be used to extract a facial image or other identifying information related to one or more users. Notably, this analysis may be performed locally (e.g., on controller 210) or may be transmitted to a remote server (e.g., in a distributed computing environment such as the “cloud,” “fog,” and/or “edge,” as those of ordinary skill in the art will recognize as referring to a system of one or more remote servers or databases including at least one remote computing device) for analysis. Such analysis is intended to facilitate user detection, e.g., by identifying a user accessing the household appliance, such as a user who may be operating, e.g., activating or adjusting, one or more user input devices 102 of the household appliance 10, such as to verify or detect an intentional manipulation of the one or more user input devices 102. In some embodiments, the analysis may be performed locally or on the edge, which may, e.g., provide a quicker response time, and such improved response time may advantageously provide a more rapid response to unintentional inputs, such as when a heating element of the household appliance may be unintentionally activated. As will be described in more detail below, such identification may also include determining whether the user input is an intentional input, e.g., from an authorized user, or an unintentional input, such as from an unauthorized user such as a child, an elderly or infirm person, or a pet, etc., or from an unrecognized user or when no user presence is detected.

Specifically, according to an exemplary embodiment as illustrated in FIG. 5, camera 192 (or multiple cameras 192 in the camera assembly 190 collectively) may be oriented away from a center of cabinet 12 and define a field of view 194 (e.g., as shown schematically in FIG. 5) that covers an area in front of cabinet 12. In this manner, the field of view 194 of camera 192, and the resulting images obtained, may capture any motion or movement of a user accessing or operating the household appliance 10. The images obtained by camera assembly 190 may include one or more still images, one or more video clips, or any other suitable type and number of images suitable for detection and/or identification of a user.

Notably, camera assembly 190 may obtain images upon any suitable trigger, such as a time-based imaging schedule where camera assembly 190 periodically images and monitors the field of view, e.g., in and/or in front of the household appliance 10. According to still other embodiments, camera assembly 190 may periodically take low-resolution images until motion (such as approaching the household appliance, opening the door 106, or reaching for one of the user input devices 102) is detected (e.g., via image differentiation of low-resolution images), at which time one or more high-resolution images may be obtained. According to still other embodiments, household appliance 10 may include one or more motion sensors (e.g., optical, acoustic, electromagnetic, etc.) that are triggered when an object or user moves into or through the area in front of the household appliance 10, and camera assembly 190 may be operably coupled to such motion sensors to obtain images of the object during such movement. In some embodiments, the camera assembly 190 may only obtain images when the household appliance is activated or attempted to be activated, e.g., when one or more of the user input devices 102 receives an input or possible input. Thus, for example, when the household appliance 10 is active, e.g., cooking, drying, or otherwise operating, the camera assembly 190 may then continuously or periodically obtain images, or may apply the time-based imaging schedule, motion detection based imaging, or other imaging routines/schedules throughout the time that the household appliance is operating.

It should be appreciated that the images obtained by camera assembly 190 may vary in number, frequency, angle, resolution, detail, etc. in order to improve the clarity thereof. In addition, according to exemplary embodiments, controller 210 may be configured for illuminating a light (not shown) while obtaining the image or images. Other suitable imaging triggers are possible and within the scope of the present subject matter.

Using the teachings disclosed herein, one of skill in the art will understand that the present subject matter can be used with various other types of household appliances, e.g., as described above. Accordingly, it is to be understood that the household appliance configurations shown in the accompanying FIGS. and the descriptions of particular exemplary household appliances set forth herein are by way of example for illustrative purposes only.

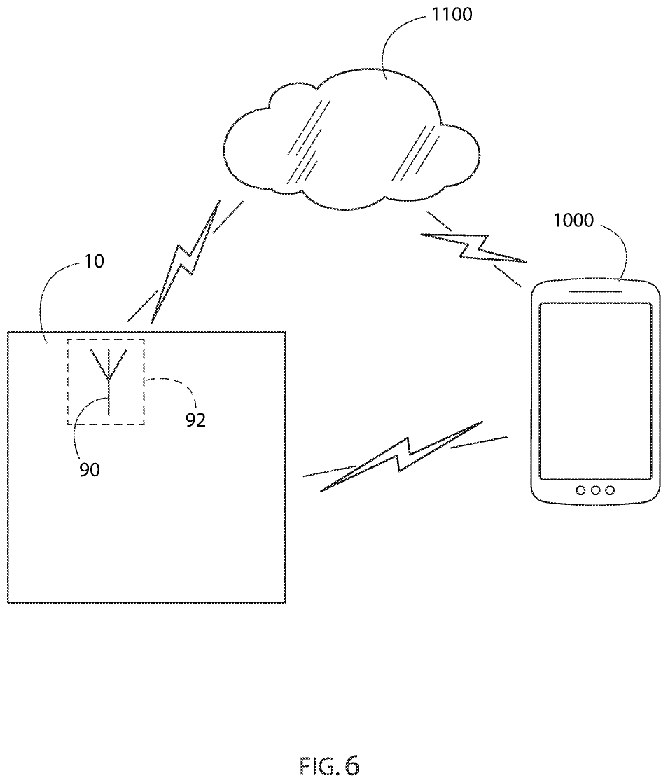

Turning now to FIG. 6, a general schematic is provided of a household appliance 10, which communicates wirelessly with a remote user interface device 1000 and a network 1100. For example, as illustrated in FIG. 6, the household appliance 10 may include an antenna 90 by which the household appliance 10 communicates with, e.g., sends and receives signals to and from, the remote user interface device 1000. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The communications module 92 may be onboard the controller 210 or may be separate from the controller 210 and coupled to the controller 210, e.g., via a wired connection. The remote user interface device 1000 may be a laptop computer, smartphone, tablet, personal computer, wearable device, smart home system, and/or various other suitable devices.

The household appliance 10 may be in communication with the remote user interface device 1000 device through various possible communication connections and interfaces. The household appliance 10 and the remote user interface device 1000 may be matched in wireless communication, e.g., connected to the same wireless network. The household appliance 10 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the household appliance 10, e.g., the remote user interface device 1000 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1000, such as a smartphone (e.g., as illustrated in FIG. 6), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 160. For example, the remote user interface device 1000 may be a smartphone operable to store and run applications, also known as “apps,” and the additional user interface may be provided as a smartphone app.

As mentioned above, the household appliance 10 may also be configured to communicate wirelessly with a network 1100. The network 1100 may be, e.g., a cloud-based data storage system including one or more remote computing devices such as remote databases and/or remote servers, which may be collectively referred to as “the cloud.” For example, the household appliance 10 may communicate with the cloud 1100 over the Internet, which the household appliance 10 may access via WI-FI®, such as from a WI-FI® access point in a user's home.

According to various embodiments of the present disclosure, the household appliance 10 may take the form of any of the examples described above, or may be any other household appliance. Thus, it will be understood that the present subject matter is not limited to any particular household appliance.

It should be understood that “household appliance” and/or “appliance” are used herein to describe appliances typically used or intended for common domestic tasks, such as a laundry appliance, e.g., as illustrated in FIGS. 1 and 2, a cooking appliance, e.g., as illustrated in FIGS. 3 and 4, or an air conditioning appliance, a dishwashing appliance, a refrigerator, a water heater, etc., and any other household appliance which performs similar functions in addition to network communication and data processing. Thus, devices such as a personal computer, router, and other similar devices whose primary functions are network communication and/or data processing are not considered household appliances as used herein.

Now that the construction and configuration of household appliance 10 have been presented according to an exemplary embodiment of the present subject matter, exemplary methods for operating a household appliance 10, such as a dryer appliance, oven appliance, or other household appliance, are provided. In this regard, for example, controller 210 may be configured for implementing some or all steps of one or more of the following exemplary methods. However, it should be appreciated that the exemplary methods are discussed herein only to describe exemplary aspects of the present subject matter, and are not intended to be limiting.

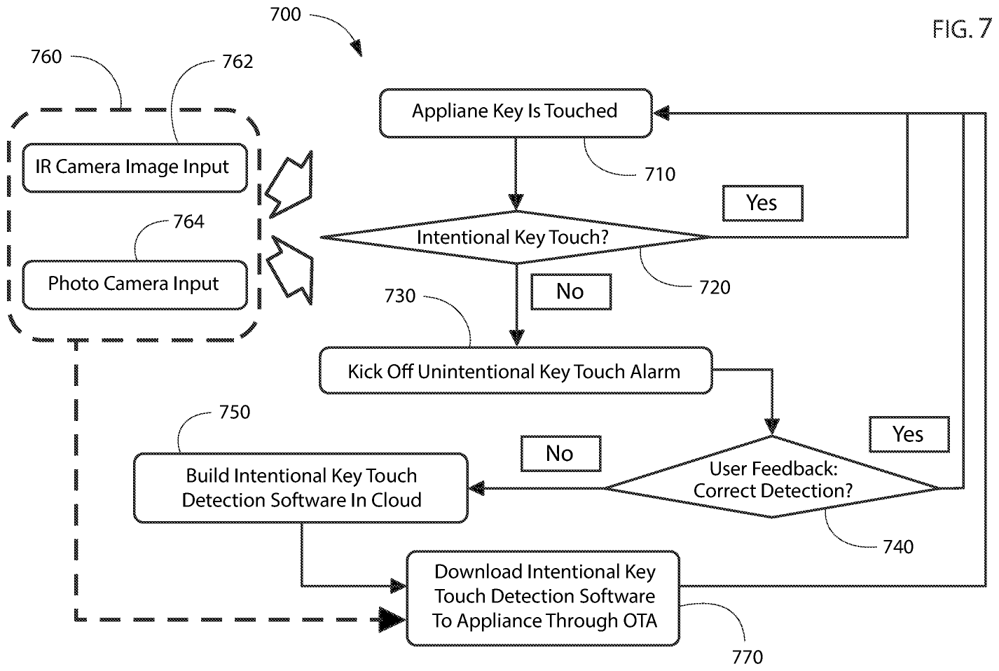

An exemplary method 700 of operating a household appliance is illustrated in FIG. 7. Such methods according to various embodiments of the present disclosure may include verifying an input received at a user input device of the household appliance, such as determining whether the input was intentional or unintentional. In FIG. 7 and the accompanying description, the user input device is a key that may be touched, by way of example. This example is provided for illustrative purposes only. In other embodiments, the user input may also or instead include a voice command, a touch on a touchscreen interface, or other user input devices and corresponding user inputs, such as toggling a switch, rotating a knob, etc., among other possible examples which may be provided separately or in combination with the exemplary key.

In some embodiments, method 700 may include a step 710 of detecting an input at a user input device of the household appliance, such as a touch at an appliance key. The input, e.g., touch, may correspond to an activation command, e.g., turning on the household appliance from an inactive state, or a change or adjustment to an operation of an already-activated household appliance.

Method 700 may further include a step 720 of determining whether the input, e.g., touch, was intentional. For example, an input verification software may be used to determine whether the input was intentional. In at least some embodiments, the input verification software may be implemented locally, e.g., a local controller of the household appliance 10 obtains and analyzes data related to the input or potential input and runs the input verification software to determine whether the input was intentional. After determining whether the input was intentional, the method 700 may then return to 710 and look for further inputs when the input is determined to have been intentional, e.g., as shown in FIG. 7. When the input is determined not to have been intentional, e.g., to have been unintentional, method 700 may then proceed to step 730 and initiate or kick off an unintentional touch alarm. The alarm may be a visual and/or audible alert. For example, the alarm may be a local alarm, e.g., on the household appliance. In particular, the local alarm may deter or repel unintended users from touching the household appliance, and/or may encourage the unintended users to move away from the household appliance, thereby reducing or preventing further unintentional inputs, e.g., touches. Additionally, the local alarm may be loud enough or bright enough to attract the attention of an intended user, and/or a remote alarm, e.g., on a remote user interface device, may be provided to alert the intended user. The intended user may be, e.g., an adult, who may have left the area of the household appliance and/or whose attention may have been diverted from the household appliance.

In some embodiments, the method 700 may include including receiving a user feedback 740 regarding whether the unintentional input was correctly detected or not. For example, when the input was actually intentional but was determined not to have been intentional, then such detection would be an incorrect detection. The method 700 may also include sending a verification message or prompt, e.g., on the remote user interface device or on a local user interface of the household appliance, and the user feedback 740 may be received in response to the verification message or prompt.

When the detection was correct, e.g., when the input was actually unintentional, the detection may be recorded in a confirmed unintentional input history. The confirmed unintentional input history may be stored locally, e.g., in a memory of the controller 210 or other memory in the household appliance 10, and/or remotely, e.g., in a remote database such as in the cloud. For example, the confirmed unintentional input history may be stored both locally and remotely, and may be synchronized between the local storage and the remote storage. For example, when an unintentional input, e.g., touch, occurs while a network is down or the household appliance is otherwise offline, the local history will capture the unintentional input and will update the remote version, e.g., the unintentional input history stored in the cloud, when the network connection is restored. The confirmed unintentional input history may also include additional data associated with each confirmed unintentional input, such as biometric data associated with one or more users, a date and/or time of day when the unintentional input was detected, a status of the household appliance at the time of the input and/or just prior to the input, or other data. The biometric data may be obtained when the input, e.g., touch, at the user input device is detected, and may also or instead be obtained within a predetermined time frame, e.g., a few minutes, before and/or after the input is detected.

When the detection was incorrect, the incorrect detection may be a learning opportunity, e.g., as described in the following, after being notified of the incorrect detection, the method may include a step 750 of updating or rebuilding the input verification software with data corresponding to the incorrect detection, e.g., biometric data and/or chronological data, etc., as described above, such that the household appliance learns from the incorrect detection and improves the input verification after the incorrect detection. For example, when the result of step 740 (e.g. the response to the confirmation message or prompt) is negative, the method 700 may then proceed to a step 750 of rebuilding or updating the input verification software, e.g., by a remote computing device such as in the cloud. The data corresponding to the incorrect detection may include camera data, e.g., camera image input, 760. The camera image input 760 may include IR camera image input 762 and/or photo camera image input 764. For example, the camera image input 760 may include an image or images obtained when the input is detected, e.g., at steps 710 and/or 720.

Rebuilding or updating the input verification software, e.g., at step 750, may include, for example, re-training a machine learning image recognition model (e.g., neural network), or otherwise updating and/or replacing an image processing, image analysis, and/or image recognition algorithm, examples of which are described in more detail below.

After rebuilding the input verification software, the new input verification software, such as a new or updated version of the input verification software, may be downloaded to the household appliance, e.g., as indicated at step 770 in FIG. 7, such as over the air (“OTA”), e.g., wirelessly, from the remote computing device to the household appliance.

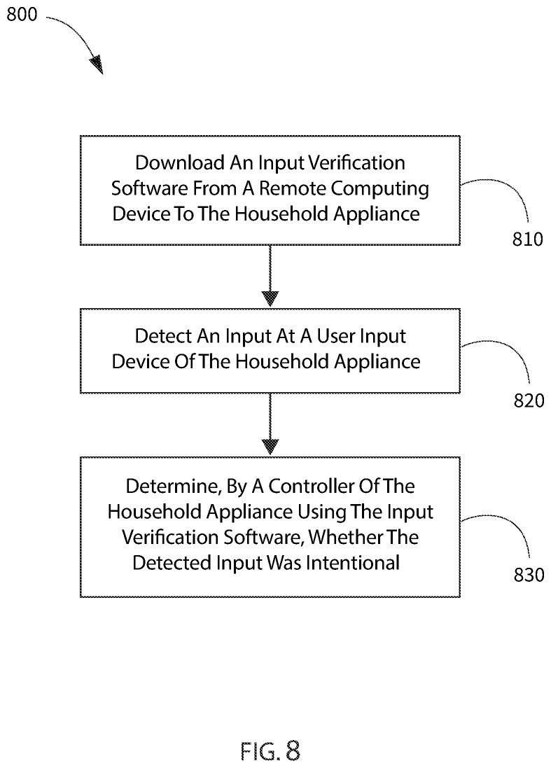

Turning now to FIG. 8, embodiments of the present disclosure may include a method 800 of operating a household appliance, such as the exemplary household appliance 10 described above. For example, the household appliance may include a user input device, such as a touchpad, key, and/or touchscreen, as described above, and a controller in operative communication with the user input device.

As shown in FIG. 8, method 400 includes, at step 810, downloading an input verification software from a remote computing device to the household appliance. As noted above, the remote computing device may include a remote database, remote server, and other similar devices, which may be a distributed computing network, such as may be referred to as “the cloud,” or a part of such network.

Method 800 may further include a step 820 of detecting an input at the user input device. For example, the user input device may be touch-sensitive, such as a touchpad, key, or touchscreen, and the detected input may be a touch. As additional examples, the user input device may be a knob and the input may be turning, e.g., rotation of the knob, the user input device may be a switch and the input may be a toggle of the switch. In some embodiments, one or more user input devices, of the same or varying types, may be provided, and an input may be detected from any one or more of such user input devices.

Method 800 may then include a step 830 of determining whether the detected input was intentional. Such determination may be performed by the controller of the household appliance using the input verification software. Thus, the computing in method 800 may be local or predominantly local, such as the input detection and verification may be carried out by the controller of the household appliance, including image processing and analysis. Accordingly, in some embodiments, the input verification may be performed without a network connection (once the input verification software has been downloaded, which may be performed pre-sale, e.g., in a factory or other manufacturer facility, and/or post-sale, e.g., when commissioned to an end user's network and internet connection).

In some embodiments, the household appliance may also include a mechanical component, and methods according to the present disclosure may further include activating the mechanical component after determining, by the controller of the household appliance using the input verification software, that the detected input was intentional. Activating the mechanical component may include causing at least one mechanical component of the household appliance to be operated. For example, the mechanical component may be a motor, such as the motor 31 of the dryer appliance, a fan, a heating element such as heating element 142 of the oven appliance, a pump, a compressor, or a valve, among other possible example mechanical components of a household appliance. Also, activating the mechanical component includes changing a physical status of the component, e.g., a speed, position, etc. of the component, such as accelerating the motor, fan, etc., e.g., from a zero starting speed, opening a valve, and/or other changes in the physical state of one or more mechanical components of the household appliance.

In some embodiments, methods according to the present disclosure may further include locking the user input device of the household appliance after determining, by the controller of the household appliance using the input verification software, that the detected input was not intentional. When the user input device is locked, the household appliance, such as mechanical components thereof (e.g., one or more heating elements, pumps, and/or motors) will not be activated in response to inputs or manipulation (e.g., button pressing) of the user input devices or user interface.

In some embodiments, methods according to the present disclosure may also include sending a user notification after determining, by the controller of the household appliance using the input verification software, that the detected input was not intentional, and receiving a response to the notification, wherein the response comprises an incorrect detection input. For example, the notification may be sent to a remote user interface device, such as a text message sent to a phone, an email which may be accessible on various devices, an audible notification broadcast from a smart speaker, or other suitable user notification. For example, the user notification sent to the remote user interface device may inform an absent authorized user of the unintentional input, e.g., by an unauthorized user. The absent user may be, for example, an authorized or intended user, e.g., an adult, who may have left the area of the household appliance and/or whose attention may have been diverted from the household appliance.

In some embodiments, the controller of the household appliance may also be in communication with a camera assembly operable to obtain an image. For example, as described above, the camera assembly may include one or more cameras in, on, or proximate to the household appliance and the one or more cameras may define a field of view which encompasses the household appliance, portions thereof, and/or an immediately adjacent area to the household appliance, such as the area in which a user is likely to be located when accessing the household appliance. In such embodiments, methods according to the present disclosure may further include obtaining one or more images with the camera assembly. For example, the one or more images may be obtained when the input at the user interface device is detected, and/or shortly before or after the input is detected. Such methods may also include, in some embodiments, after receiving the incorrect decision input, transmitting the one or more images to the remote computing device from the household appliance.

The image(s) may then be used to rebuild the input verification software, e.g., in the cloud, such as the input verification software may incorporate the one or more images or may train an image analysis or image recognition algorithm using the one or more images. For example, methods according to the present disclosure may also include updating the input verification software by the remote computing device based on the one or more images. In such embodiments the updated input verification software may then be downloaded from the remote computing device to the household appliance.

In such embodiments, the controller 210 of the household appliance 10 may be configured for image-based processing, e.g., to detect a user and identify the user, e.g., determine whether the user is an authorized user based on an image of the user, e.g., a photograph taken with the camera(s) 192 of the camera assembly 190. For example, the controller 210 may be configured to identify the user by comparison of the image to a stored image of a known or previously-identified user. For example, controller 210 of household appliance 10 (or any other suitable dedicated controller) may be communicatively coupled to camera assembly 190 and may be programmed or configured for analyzing the images obtained by camera assembly 190, e.g., in order to detect a user accessing or proximate to household appliance 10 and to identify the user, e.g., to thereby determine whether an input by the user is an intentional or unintentional input.

In some exemplary embodiments, methods according to the present disclosure may include analyzing one or more images to detect and/or identify a user. It should be appreciated that this analysis may utilize any suitable image analysis techniques, image decomposition, image segmentation, image processing, etc. This analysis may be performed entirely by controller 210, may be offloaded to a remote server (e.g., in the cloud 1100) for analysis, may be analyzed with user assistance (e.g., via user interface panel 100), or may be analyzed in any other suitable manner. According to exemplary embodiments of the present subject matter, the analysis may include a machine learning image recognition process.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor household appliance 10 and/or a proximate and contiguous area in front of the household appliance 10. It should be appreciated that this image analysis or processing may be performed locally (e.g., by controller 210) or remotely (e.g., by offloading image data to a remote server or network, e.g., in the cloud).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. In a particular example, the reference images may be images of the face or faces of one or more authorized users and of one or more protected users, e.g., in a database as described above, such that the extant particular condition in the reference images is the presence of an authorized user and/or of a protected user. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image (the term “object” is used broadly herein to include humans, e.g., users of the household appliance). In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 210 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region-based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object (e.g., a human or animal face) or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) having multiple convolutional layers (conv1 through convX, where “X” is the last convolutional layer, e.g., five convolutional layers, conv1 through conv5), and then allocates it to zone recommendations on the convX, e.g., conv5, property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the steps of detecting and identifying a user may include analyzing the one or more images using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described methods or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset, then the last layer may be retrained with an appliance-specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners, such as by different users. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

When the household appliance detects an input at the user input device and then determines that the input was unintentional, the household appliance may then gather data, e.g., obtain images with one or more cameras. The household appliance may also or instead gather such data in response to an incorrect determination. The gathered data may be used to rebuild or update the input verification software. For example, the input verification software may be built by a remote server, e.g., in the cloud, and downloaded by the household appliance, such as transmitted from the remote server and received by the household appliance. Then, at a subsequent unintentional input detections (which may be determined automatically, e.g., by analyzing sensor input such as camera images, and/or based on manual user input) additional data may be gathered and such additional data may be sent to the cloud, such as transmitted from the household appliance and received by the remote server. The remote server may then use the additional data to update and/or rebuild the input verification software. The updated input verification software may then be transmitted to, e.g., re-downloaded by, the household appliance. Accordingly, the input verification software may be continuously updated and the accuracy of the input verification software may be continuously improved with additional data. In particular, the remote server may be in communication with numerous household appliances, may receive data from multiple of the household appliances, and may update the input verification software based on all the data from the multiple household appliances.

In some embodiments, methods according to the present disclosure may also include obtaining biometric data associated with a user, and, after receiving the incorrect decision input, transmitting the biometric data to the remote computing device from the household appliance. For example, obtaining or recording biometric data may include recording a voice of one or more users, scanning the faces of one or more users, scanning fingerprints of one or more users, other suitable biometric data, or combinations of two or more forms of biometric data. For example, the users' faces may be scanned with a camera assembly of the household appliance, e.g., such as the camera assembly described above with respect to FIG. 5, or a remote user interface device, e.g., as described above with respect to FIG. 6, or any other suitable image-capture device which can communicate (directly or indirectly) with the household appliance and/or one or more remote computing devices. Thus, for example, the biometric data may include facial recognition images, a voice print or voice recognition data, an iris scan, other similar biometric data, or combinations thereof.

In some embodiments where the controller of the household appliance is further in communication with a camera assembly operable to obtain an image, the step of determining, by the controller of the household appliance using the input verification software, whether the detected input was intentional may include obtaining one or more images from the camera assembly and determining whether the detected input was intentional based on the presence or absence of a user in the one or more image. For example, such embodiments may include determining the input was intentional based on the presence of any user at all, e.g., verifying the input based on the presence of a human at the user input device. For example, the user detection may include detecting an authorized user when the authorized user has been set up or previously identified, or the user detection may simply include using fuzzy logic to check if a real person is present when an authorized user is not set up.

In some embodiments, methods according to the present disclosure may further include obtaining biometric data associated with a user. In such embodiments, determining, by the controller of the household appliance using the input verification software, whether the detected input was intentional may include identifying the user based on the biometric data, and determining that the input was intentional when the user is an authorized user and determining that the input was not intentional when the user is not an authorized user.

In some embodiments, methods according to the present disclosure may further include locking the user input device of the household appliance prior to detecting the input at the user input device. For example, the user input device may be locked based on a command or input from an authorized user, e.g., an adult when leaving the house while children are at home. As another example, the user input device may be locked based on a time schedule, e.g., the user input device may be programmed to lock (e.g., the controller 210 of the household appliance 10 may automatically lock the user input device according to a predetermined schedule which may be set by an authorized user). For example, the time schedule may lock the user input device when children return home from school and keep the user input device locked until a parent gets home from work. In such embodiments, the user input device may unlock automatically, e.g., according to a time schedule as mentioned, or may be manually unlocked by an authorized user, such as by detecting an input at the user input device and unlocking the user input device after determining, by the controller of the household appliance using the input verification software, that the detected input was intentional.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a household appliance, the household appliance comprising a user input device and a controller in operative communication with the user input device, the method comprising:
downloading an input verification software from a remote computing device to the household appliance;
detecting an input at the user input device; and
determining, by the controller of the household appliance using the input verification software, whether the detected input was intentional.

2. The method of claim 1, wherein the household appliance further comprises a mechanical component, and wherein the method further comprises activating the mechanical component after determining, by the controller of the household appliance using the input verification software, that the detected input was intentional.

3. The method of claim 1, further comprising locking the user input device of the household appliance after determining, by the controller of the household appliance using the input verification software, that the detected input was not intentional.

4. The method of claim 1, further comprising sending a user notification after determining, by the controller of the household appliance using the input verification software, that the detected input was not intentional, and receiving a response to the notification, wherein the response comprises an incorrect detection input.

5. The method of claim 4, wherein the controller of the household appliance is also in communication with a camera assembly operable to obtain an image, the method further comprising obtaining one or more images with the camera assembly, and, after receiving the incorrect detection input, transmitting the one or more images to the remote computing device from the household appliance.

6. The method of claim 5, further comprising updating the input verification software by the remote computing device based on the one or more images, and downloading the updated input verification software from the remote computing device to the household appliance.

7. The method of claim 4, further comprising obtaining biometric data associated with a user, and, after receiving the incorrect detection input, transmitting the biometric data to the remote computing device from the household appliance.

8. The method of claim 1, wherein the controller of the household appliance is further in communication with a camera assembly operable to obtain an image, wherein determining, by the controller of the household appliance using the input verification software, whether the detected input was intentional comprises obtaining one or more images from the camera assembly and determining whether the detected input was intentional based on presence or absence of a user in the one or more image.

9. The method of claim 1, further comprising obtaining biometric data associated with a user, wherein determining, by the controller of the household appliance using the input verification software, whether the detected input was intentional comprises identifying the user based on the biometric data, and determining that the input was intentional when the user is an authorized user and determining that the input was not intentional when the user is not an authorized user.

10. The method of claim 1, further comprising locking the user input device of the household appliance prior to detecting the input at the user input device, and unlocking the user input device after determining, by the controller of the household appliance using the input verification software, that the detected input was intentional.

11. A household appliance, comprising:
a user input device; and
a controller in operative communication with the user input device,
wherein the controller is configured for:
downloading an input verification software from a remote computing device to the household appliance;
detecting an input at the user input device; and
determining, using the input verification software, whether the detected input was intentional.

12. The household appliance of claim 11, further comprising a mechanical component, wherein the controller is further configured for activating the mechanical component after determining, using the input verification software, that the detected input was intentional.

13. The household appliance of claim 11, wherein the controller is further configured for locking the user input device after determining, using the input verification software, that the detected input was not intentional.

14. The household appliance of claim 11, wherein the controller is further configured for sending a user notification after determining, using the input verification software, that the detected input was not intentional, and receiving a response to the notification, wherein the response comprises an incorrect detection input.

15. The household appliance of claim 14, wherein the controller of the household appliance is also in communication with a camera assembly operable to obtain an image, wherein the controller is further configured for obtaining one or more images from the camera assembly, and, after receiving the incorrect detection input, transmitting the one or more images to the remote computing device.

16. The household appliance of claim 15, wherein the controller is further configured for, after transmitting the one or more images to the remote computing device, downloading an updated input verification software from the remote computing device to the household appliance.

17. The household appliance of claim 14, wherein the controller is further configured for obtaining biometric data associated with a user, and, after receiving the incorrect detection input, transmitting the biometric data to the remote computing device.

18. The household appliance of claim 11, wherein the controller of the household appliance is further in communication with a camera assembly operable to obtain an image, wherein determining, using the input verification software, whether the detected input was intentional comprises obtaining one or more images from the camera assembly and determining whether the detected input was intentional based on presence or absence of a user in the one or more image.

19. The household appliance of claim 11, wherein the controller is further configured for obtaining biometric data associated with a user, wherein determining, using the input verification software, whether the detected input was intentional comprises identifying the user based on the biometric data, and determining that the input was intentional when the user is an authorized user and determining that the input was not intentional when the user is not an authorized user.

20. The household appliance of claim 11, wherein the controller is further configured for locking the user input device of the household appliance prior to detecting the input at the user input device, and unlocking the user input device after determining, using the input verification software, that the detected input was intentional.
